(19) United States
(12) Patent Application Publication
(10) Pub. No.: US 2006/0044590 A1
(43) Pub. Date: Mar. 2, 2006

(54) System and method for network scan debt authorization

(75) Inventors: Andrew Rodney Ferlitsch, Tigard, OR (US); Tanna Marie Richardson, Happy Valley, OR (US)

Correspondence Address: Gerald W. Maliszewski, P.O. Box 270829, San Diego, CA, 92198-2829, US

(73) Assignee: Sharp Laboratories of America Inc.

(21) Appl. No.: 10/929,955

(22) Filed: Aug. 30, 2004

(51) Int. Cl. G06K 15/00; G06F 15/00; G06Q 40/00

(52) U.S. Cl. 358/1.14; 705/39

(57) ABSTRACT

A system and method are provided for network scan debt authorization. The method comprises: accepting a hardcopy document at an imaging device; predetermining the cost for scanning the document; debiting an account; authorizing a network scan; and, sending scanned image data to a destination. The process of predetermining the cost of scanning the document either measures the hardcopy document or measures a scanned image data version of the hardcopy document. If the hardcopy document is measured, then information is collected such as the number of sheets, the sheet sizes, and the sheet sides used (simplex/duplex). If the scanned image data is measured, then the document can be scanned and a count made of the number of image pages in the scanned image data. Alternately, or in addition to page-count, the amount of content in the scan image data can be measured.

### BACKGROUND OF THE INVENTION

1. Field of the Invention

This invention generally relates to digital document processing and, more particularly, to a system and method for authorizing network scans and debiting associated accounts.

2. Description of the Related Art

When an operator configures an imaging device, such as a multifunctional peripheral (MFP), to operate on a debit authorization basis, it would be desirable to have all imaging operations operate on the debit authorization basis. Conventionally, means have existed for enabling copying, printing, and faxing operations for debt authorization, but not for a scan-to-destination, such as network scan or scan-to-image store operations. The cost-associated parameters, such as page-count, of print jobs are known before printing, even though the job is in an electronic format. Therefore, the cost can be predetermined by analysis, and an account debited before the job is actually performed. However, when the job input is a hardcopy, it is difficult for the imaging device to predetermine cost parameters and, therefore, debit an account before performing the job.

FIG. 1 is a diagram depicting a manual network scan monitoring system (prior art). One method to obtain click counts for network scanning or scan-to-image store operations, is for the device to maintain the counts internally. The operator can then periodically view the counts (manually) from the device's control panel or from a remote interface. For example, an embedded device web page can be used to access the count. This method has limitations in that: the operation is manual; the operator has to be physically present at the device (if from control panel) or within the corporate firewall (if from embedded web page); and, there is no debit authorization method. The Sharp AR-N275 is an example of a device that does network scan accounting using this method.

FIG. 2 is a diagram depicting an external site monitoring system (prior art). As an improvement over the system of FIG. 1, this device is able to periodically export in an automated method, for example send via email, the total scan counts to an external site outside the corporate firewall. The external site can then process the scan accounting data either manually or in an automated fashion. This method still has limitations in that there is no debit authorization method. Sharp Remote Email Diagnostics is an example of a multifunctional peripheral (MFP) application service that uses this method.

FIG. 3 is a diagram depicting a coin-operated accounting system (prior art). While debit authorization solutions for network scan operations are not well developed, they are for other imaging operations, such as for walkup copy operations. These devices have an external vendor control interface (VCI) that can be connected to an external device, such as a coin-op box. The VCI uses an inbound pulse to enable/disable the copier and an outbound pulse to count the number of impressions printed/outputted by the device (clicks). For example, if the coin-op charges five cents and the user inserts 25 cents, the coin-op box sends an inbound enable pulse to the device. For each printed page outputted, the device sends an outbound click pulse. For each received click pulse, the coin-op debits five cents. Once 5 pulses are received (i.e., the balance goes to zero), the coin-op box sends an inbound disable pulse. This method still suffers in that it: can only handle copy operation; and, cannot work with a pre-authorization debit. That is, there is no way to know ahead of time if the customer has enough money to complete the entire job.

FIG. 4 is a diagram illustrating a print job authorization system (prior art). For printing operations, such as a print job sent from a personal computer (PC) to a printer, debit authorization systems are more developed than for copying. In these systems, the print data for the entire job, such as PCL, Postscript, or the like, is created prior to delivery to the device. The print data therefore pre-describes all the resources and total output that will be produced once it is processed. A debit authorization system works by intercepting the print data prior to delivery, and analyzing the print data to pre-determine the amount of billable operations/materials that will be consumed. The system can then perform a debit authorization for the entire job, before releasing the print job to the printing device.

In one aspect, print jobs are routed through a print server, instead of directly to the printer. The print server then de-spools the print job to the printer via a port monitor. In this case, a custom port monitor pre-analyzes the print stream to determine the billable amount. The port monitor then communicates with an accounting process for authorization for the billable amount. If authorized, the port monitor releases the job. Otherwise, the job is not released.

This method still suffers in that it: can only handle print operations; is print language dependent—billing can only be determined if the print language can be parsed; is protocol dependent—a port monitor must be implemented for each printing protocol supported; the system does not know if the job fails to print completely—refunds for an incomplete job cannot be handled; the system (print server) maybe bypassed, in which case the job is not charged.

FIG. 5 is a diagram illustrating a protocol-independent print job authorization system (prior art). An example of this system is disclosed in published U.S. pending patent 20030090705 Providing print job accounting in a computer system configuration, Sharp, Andrew Ferlitsch. In this method, a de-spooling process upstream from the port monitor pre-analyzes the print stream to determine the billable amount, such as using a print processor in the Microsoft Windows print subsystem. The protocol independent de-spooling component then communicates with an accounting process for authorization for the billable amount. While this method solves some of the limitations associated with billing print jobs, it is not directly applicable for the billing of network scan operations.

FIG. 6 is a diagram illustrating a post-processing print job billing system (prior art). In another method of accounting for print jobs, the printing device sends the billable amount to an accounting server after the completion of the job. In this system, the billable amount is then debited from the customer's account. If the amount exceeds the current balance, a charge is added to the customer's account, so than an unpaid balance is created. See U.S. Pat. No. 6,219,151 Network printing system, Hitachi Koki Imaging System. In this system, a print job includes additional information. This information describes the communication address (e.g., IP address) of the client sending the job and of the accounting server. The device then extracts this communication addresses in addition to processing the job. When the job is completed, the device sends a job completion notification to the client's communication address and an accounting statement (e.g., account no., number of clicks, job completion status) to the accounting server's communication address. This method still suffers in that it can only handle print operation and it cannot pre-authorize a debit, so as to prevent the creation of an unpaid balance.

FIG. 8 is diagram illustrating a printer firmware pre-analysis billing system (prior art). Other print job authorization systems perform the pre-analysis step to determine the billable amount in the printer firmware, and then obtain authorization from an account server. This method prevents someone from bypassing the accounting system on a print server by directly submitting the print job to the printer. Both U.S. Pat. No. 6,064,838 Printing system that can identify printing cost beforehand, Minolta and published U.S. pending patent 20020078275 Printing system adapted to change a printing operation to be performed based on a result of an accounting operation, Canon, disclose systems using such a method. This method still suffers in that it can only handle print jobs, where the resources needed to complete that job are known before the job is performed.

FIG. 9 is a diagram illustrating a magnetic swipe card copier billing system (prior art). Several modern digital copiers used for vending operations now support using a magnetic swipe debit card for copier operations. The method works the same as the coin-op vendor control interface, except that the balance is debited from the user's debit card, or charged to a credit card. U.S. Pat. No. 6,119,934 Credit card, smart card and bank issued debit card operated system and method for processing electronic transactions, USA technologies, discloses a method for walkup imaging operations, such as copy, scan, or fax on a digital imaging device. This method is still limited in that cannot pre-authorize a debit.

Therefore, there is a need for an effective debit authorization method for network scan and scan-to-image store operations on a digital imaging copier.

It would be advantageous if a network scan billing system could be created that eliminated the possibility of unpaid balances.

It would be advantageous if the resources required to complete a network scan job could be determined, so that an account be debited, before the actual job operation.

### SUMMARY OF THE INVENTION

This application describes an effective method for a debit authorization for network scan or scan-to-image store operations on a digital imaging device. A debit authorization occurs prior to the completion of the imaging operation. It requires the user to have sufficient funds to cover the entire imaging job. Therefore, a means has been created to predetermine the entire size of the job before providing the user with any of the completed product. Three variations of debit authorization are provided herein.

Pre-Count Through Document Feeder

In this method, a document is passed twice through the automatic document feeder (ADF), an input such as a platen, or combinations thereof, so that a scan build is created. On the first pass, the document is not scanned, but the number of pages and page sizes are determined. This information is then used to make a predetermination of the cost of the job. A debit authorization is obtained, by connecting to an accounting server for example. If the debit authorization is granted, the document(s) are then passed through the ADF a second time for the full resolution scan and transmission to a destination. Otherwise, if the debit is not authorized, the document is outputted from the ADF.

Low-Resolution Pre-Scan Through Document Feeder

In this method, a document is passed twice through the ADF or other inputs. On the first pass, the document is pre-scanned at a low resolution (e.g., 75 dpi). During this pass, the number of pages, page sizes, and the accumulative total image output size at the low resolution is determined. This information is then used to make a predetermination of the cost of the job, and to obtain a debit authorization. If the debit authorization is granted, the document(s) are then passed through the ADF a second time for the full-resolution scan and transmission to a destination. Otherwise, the document is outputted from the ADF. Full-resolution scan and hold in temporary storage.

In this method, a document is passed once through the ADF or other inputs. On this only pass, the document is scanned at the full resolution (e.g., 300 dpi). During this pass, the number and sizes of pages are counted, and the accumulative total image output size at the full resolution is determined. The images are held in temporary storage. This information is then used to make a predetermination of the cost of the job, and to obtain a debit authorization. If the debit authorization is granted, the image(s) are released from temporary storage and sent to the destination. Otherwise, the image(s) are deleted from temporary storage.

Accordingly, a method is provided for network scan debt authorization. The method comprises: at an imaging device, accepting a hardcopy document; predetermining the cost for scanning the document; debiting an account; authorizing a network scan; and, sending scanned image data to a destination. The process of predetermining the cost of scanning the document either measures the hardcopy document or measures a scanned image data version of the hardcopy document.

If the hardcopy document is measured, then information is collected such as the number of sheets, the sheet sizes, and the sheet sides used (simplex/duplex). For example, the number of sheets can be counted by singly counting sheets placed on an imaging device platen, or by automatically counting sheets passed through an imaging device document feeder (ADF).

If the scanned image data is measured, then the document can be scanned and a count made of the number of image pages in the scanned image data. Alternately, or in addition to page-count, the amount of content in the scan image data can be measured. For example, a low-resolution scan of the document can be performed. The amount of data associated with each image page is measured, and the data is scaled by low-resolution/full-resolution ratio. Later, after debt authorization, full-resolution scanned image data is created and sent to a destination.

Alternately, a high-resolution scan of the document is performed. The amount of data associated with each full-resolution image page is measured, and/or the number of pages counted. Then, the full-resolution scanned image data is stored. The full-resolution scanned image data is sent from storage in response to the authorization.

Additional details of the above-described method, and a network scan debt authorization system are provided below.

### BRIEF DESCRIPTION OF THE DRAWINGS

FIG. 1 is a diagram depicting a manual network scan monitoring system (prior art).

FIG. 2 is a diagram depicting an external site monitoring system (prior art).

FIG. 3 is a diagram depicting a coin-operated accounting system (prior art).

FIG. 4 is a diagram illustrating a print job authorization system (prior art).

FIG. 5 is a diagram illustrating a protocol-independent print job authorization system (prior art).

FIG. 6 is a diagram illustrating a post-processing print job billing system (prior art).

FIG. 7 is a diagram illustrating a system that tracks the successful completion of a job.

FIG. 8 is diagram illustrating a printer firmware pre-analysis billing system (prior art).

FIG. 9 is a diagram illustrating a magnetic swipe card copier billing system (prior art).

FIG. 10 is a schematic block diagram of a network scan debt authorization system.

FIG. 11 is a diagram illustrating the hardcopy measurement aspect of the system.

FIG. 12 is a diagram featuring the low-resolution, pre-authorization scanning of the document.

FIG. 13 is a diagram illustrating the full-resolution aspect of the network scan debit authorization system.

FIGS. 14A and 14B are flowcharts illustrating a method for network scan debt authorization.

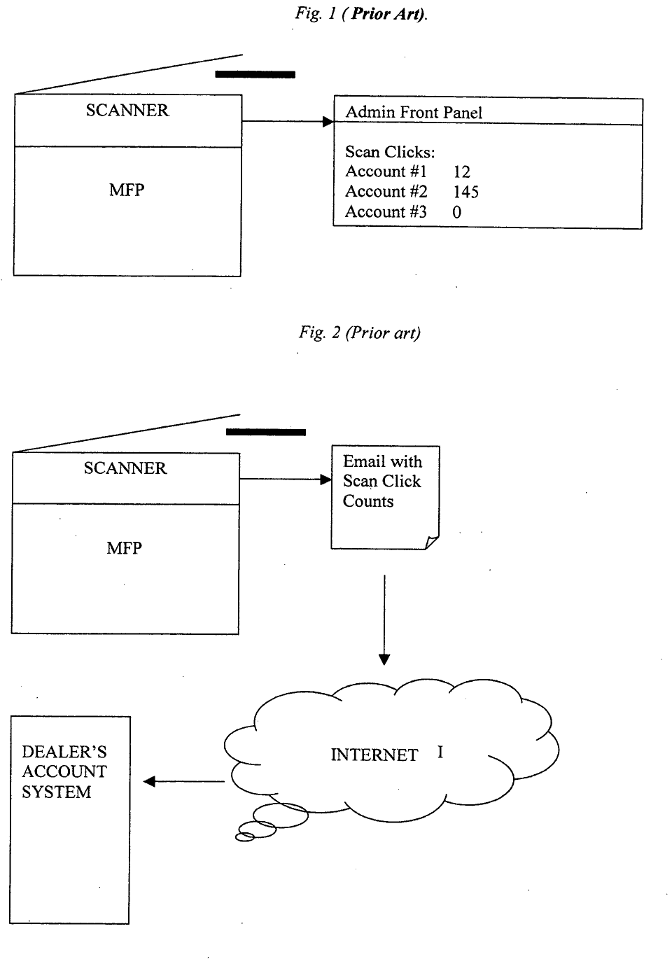

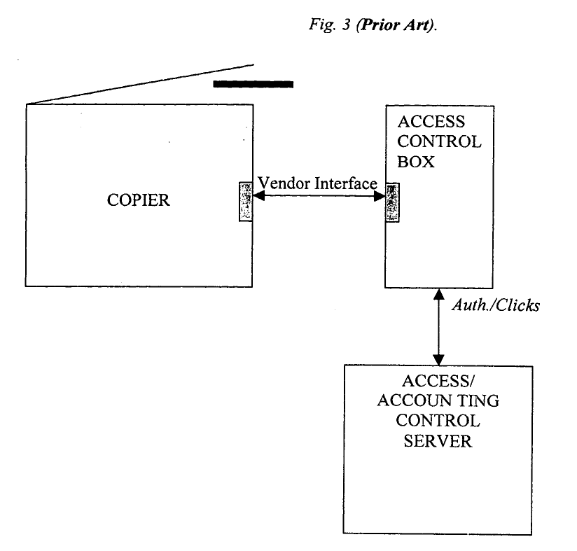

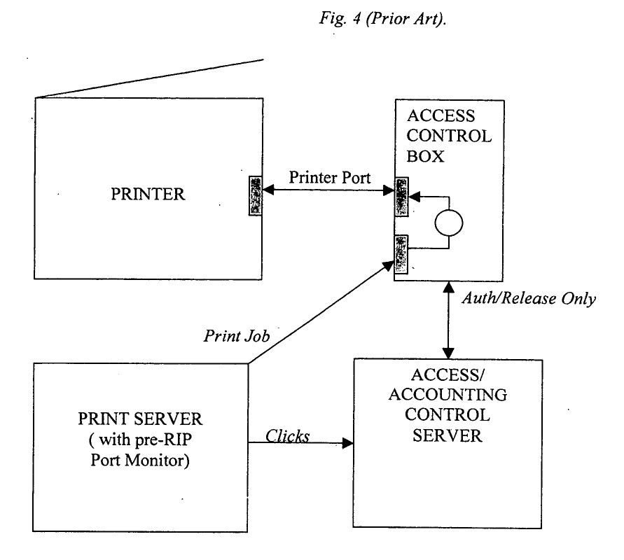

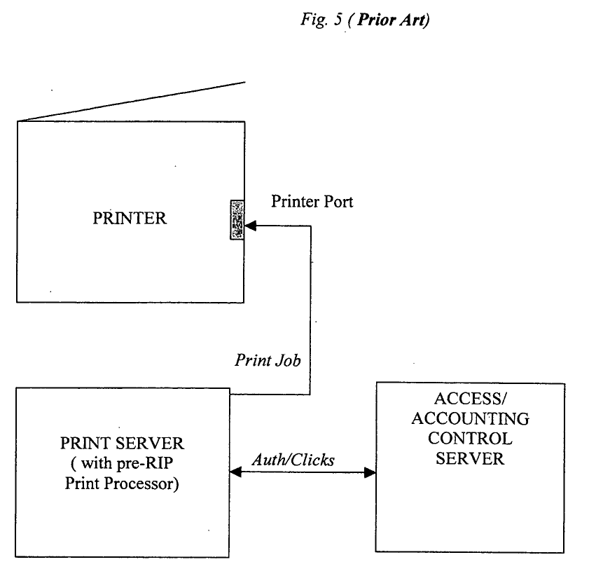

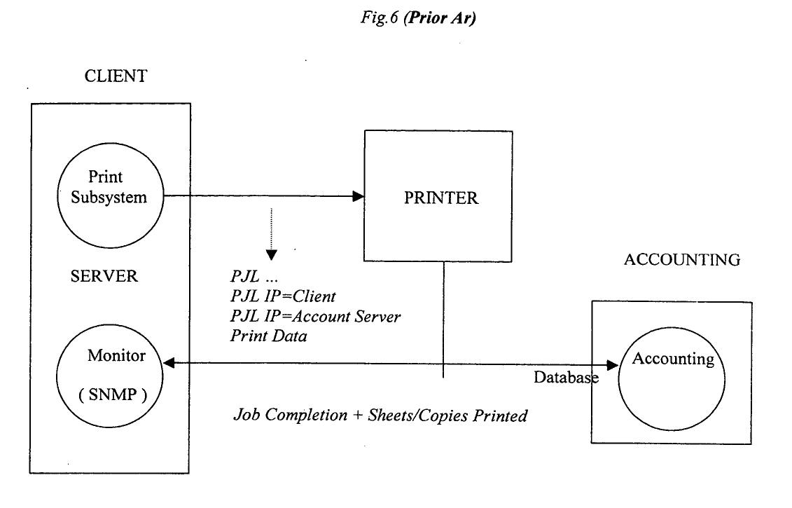

### DETAILED DESCRIPTION OF THE PREFERRED EMBODIMENTS

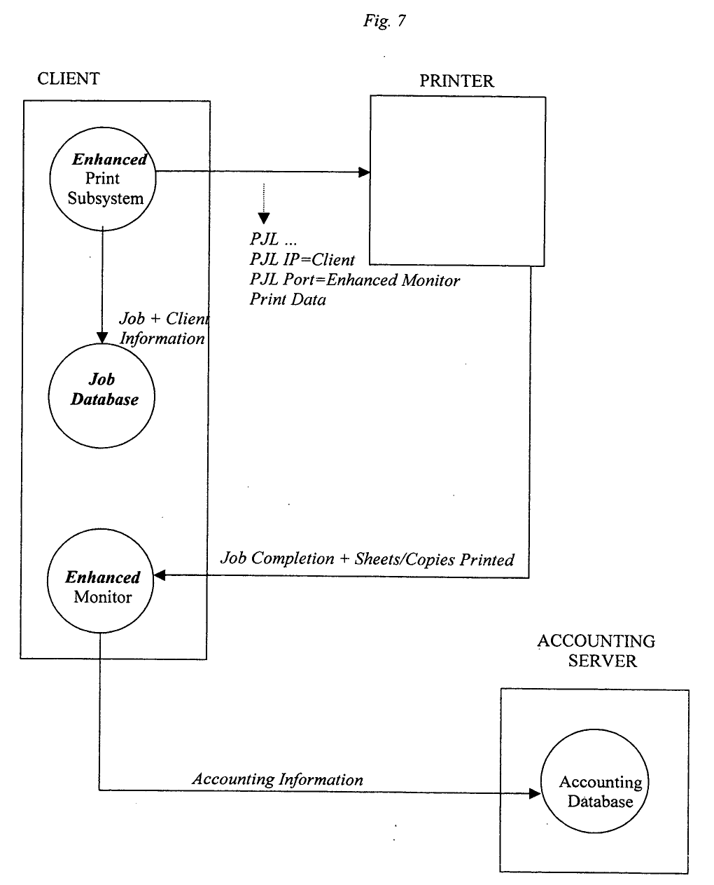

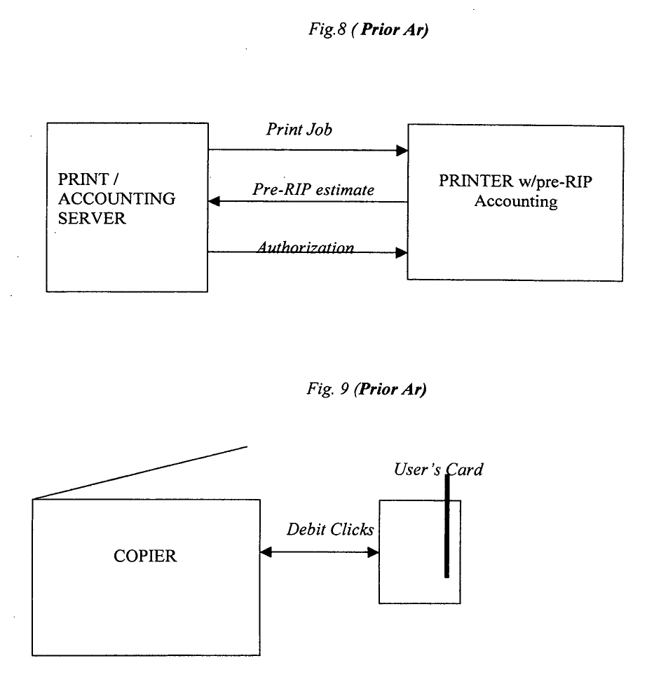

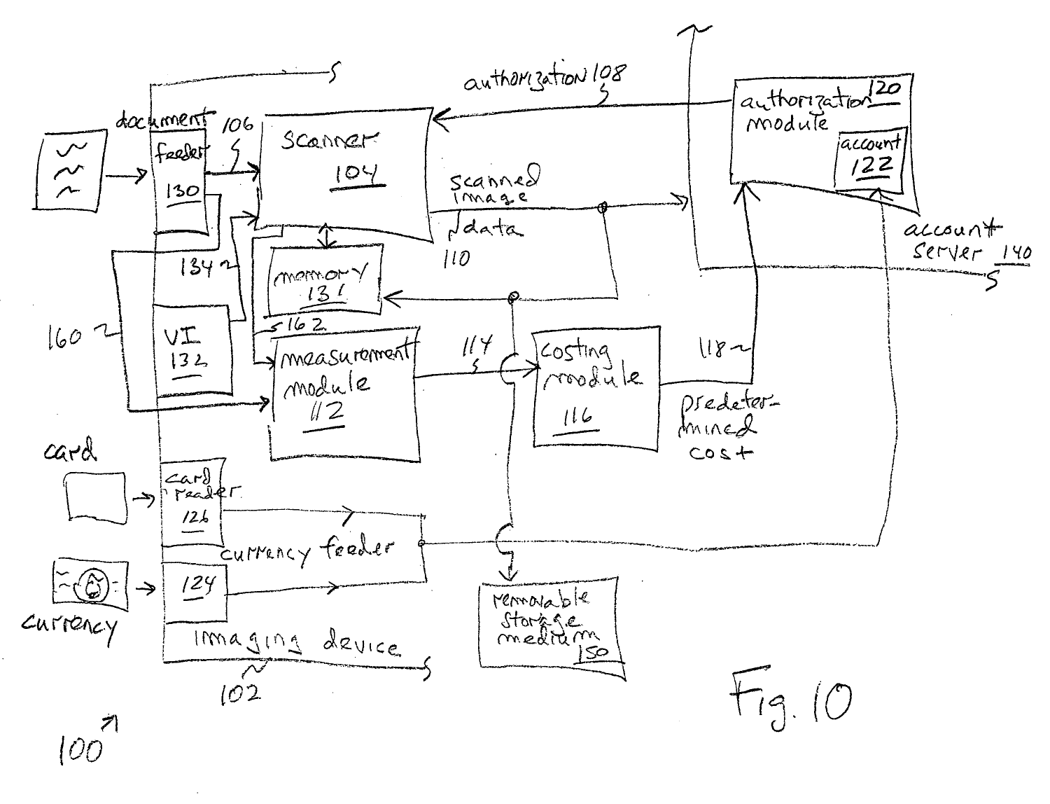

FIG. 7 is a diagram illustrating a system that tracks the successful completion of a job. In this system, a mechanism is added that sends a message back to the accounting database, indicating whether the job is successfully completed or not. The print job is first pre-analyzed for the billable amount and a debit authorization is obtained from the accounting server. The amount is not initially deducted from the account, but is instead pending. When the job is completed or fails, the printing device then sends a job completion notification to the accounting system, indicating the success or failure of the job. The accounting system then completes the transaction accordingly. This method still suffers in that: it can only handle print or print-to-fax jobs.

FIG. 10 is a schematic block diagram of a network scan debt authorization system. The system 100 comprises an imaging device 102. The imaging device 102 can be a scanner, MFP, copier, fax, print-enabled copier, or the like, that is capable of scanning a hardcopy document and creating scanned image data. The system is not limited to any particular type of imaging device. Therefore, the imaging device 102 includes a scanner 104 having an interface on line 106 to accept a hardcopy document. Typically, a hardcopy document is a paper medium, however, over physical media can be used. The scanner 104 has an interface on line 108 to accept a network scan authorization, and an interface on line 110 to supply scanned image data of the hardcopy document in response to a network scan authorization. The imaging device 102 also includes a measurement module 112 having an interface on line 114 to supply measurements associated with the document.

A costing module 116 has an interface on line 114 to accept the document measurements. The costing module 116 supplies a predetermined cost for scanning the document on line 118, in response to the document measurements. An authorization module 120 has an interface on line 118 to accept the predetermined cost. The authorization module 120 debits an account 122 in response to the predetermined cost, and supplies the network scan authorization at an interface on line 108. Note, the account 122, although shown within authorization module 120, need not necessarily reside there.

The authorization module 120 accesses the account 122 and determines available funds in the account. The authorization module 120 supplies the network scan authorization on line 108 in response to successfully deducting the debited amount from the available funds. In one aspect, the imaging device 102 includes a currency feeder 124, credit/debit card reader 126, or both. Then, the authorization module 120 funds or replenishes the account 124 by accepting credit via the currency feeder 124 or debiting a credit account via the credit/debit card reader 126. In this manner, the system 100 is able to operate with users, perhaps one-time users, who don't have a preexisting account established.

The imaging device 102 includes some kind of document feeder 130. Then, the measurement module 112 supplies measurements associated with the document by either collecting information (directly) associated with the hardcopy document from the document feeder 130 (on line 160), or by measuring a scanned image data version of the hardcopy document using data supplied on line 162.

If the measurement module 112 collects information from the document feeder 130, the document feeder supplies information in response to physically handling the hardcopy document, such as the number of sheets or the sheet sizes. Both of these factors may contribute to the job cost. Further, the document feeder may determine the sheet sides used (simplex/duplex). That is, whether the document is single or double-sided. The document feeder 130 is typically an automatic document feeder (ADF) or a scanner platen. If an ADF, the measurement module 112 may receive a total page count. If the document feeder is a platen, then the measurement module 112 counts the number of sheets in the hardcopy document by singly counting sheets placed on the platen. Note, this single-tally process might count and authorize on a sheet-by-sheet basis.

If the debit authorization is based upon a measurement of scanned image data, then the imaging device scanner 104 must scan the hardcopy document prior to receiving the network scan authorization. The measurement module 112 measures image pages in a scanned image data version of the hardcopy document by counting the number of image pages in the scanned image data. In addition to a simple page-count, the job cost might alternately, or additionally, be based upon content, for example the number of bytes in the scanned image data.

In one aspect, the imaging device scanner 104 scans the hardcopy document in low resolution prior to receiving the network scan authorization. The measurement module 112 measures the amount of data associated with each image page, calculates a low-resolution/full-resolution ratio, and scales the data by the calculated ratio. Once the imaging device scanner 104 receives the network scan authorization, it scans the document in full resolution and sends the full-resolution scanned image data on line 110.

Alternately, the imaging device scanner 104 scans the hardcopy document in full resolution prior to receiving the network scan authorization. The scanner 104 stores the full-resolution scanned image data in memory 131. Note, the memory need not necessarily reside in the imaging device 102. For example, the memory may reside in a connected server. Then, the scanner 104, or some other imaging device element, sends the full-resolution scanned image data from storage 131 in response to receiving the network scan authorization on line 108. As with the low-resolution process, the full-resolution process can be used to determine a simple page-count, or the measurement module 112 may measure the amount of data associated with each full-resolution image page.

In another aspect of the system, the imaging device 102 includes a user interface (UI) 132 having a port on line 134 to supply commands. The imaging device scanner 104, or a processor associated with the scanner (not shown) has an interface on line 134 to accept the UI commands. In response to the UI commands, the scanner 104 may perform scanning options related to cropping, gray scale, color adjustment, resolution, compression, or output format. The costing module 116 may supply a predetermined cost, at least partially in response to selected scanning options.

Further, the imaging device scanner 104, or an associated processor (not shown), may perform post-scanning options in response to the UI commands on line 134. These options might include encryption, embedding digital signatures, annotation, or optical character recognition (OCR) processes. Again, the costing module 116 may supply a predetermined cost on line 118 in response to selected post-scanning options.

The imaging device UI 132 may incorporate features such as a keyboard, magnetic card reader, optical reader, barcode scanner, biometric reader, or a smart card reader. Assuming the user has a preexisting account 124 established, the authorization module 120, prior to debiting the account, receives account identification information via the imaging device UI 132. For example, a user may use the UI keyboard to enter an account or PIN number.

In another aspect, the imaging device scanner 104 sends the scanned image data to a destination supplied in commands from the UI 132. The costing module 116 may predetermine the cost of scanning the document on the basis of the destination locale, transmission services, or storage services. With respect to destination locale, a surcharge may be charged for out-of-the local area destination based, upon area code or upon a geographic-based international location. With respect to transmission service, a flat rate may be charged for non-realtime deliveries such as email, and a surcharge charged for realtime deliveries such as FTP. Storage service may be charged if the destination is a permanent storage, as there may be storing fees.

The authorization module 120 may reside in the imaging device 102, in a network-connected account server 140, a locally-connected computing device (not shown), a network-connected computing device (not shown), or another imaging device (not shown) connected to the imaging device 102. For simplicity, the authorization module 120 is depicted as residing with server 140. The costing module 116 may reside with the imaging device 102, either independently, or as part of the measurement module 112. Alternately, the costing module 116 may reside with the authorization module 120.

The imaging device scanner 104 sends the scanned image data to a connected device in response to receiving the network scan authorization. The connected device might be a network-connected device, such as server 140, network-connected computer (not shown), a locally-connected device, such as computer (not shown), imaging device storage 131, or a removable storage medium device 150, such as a CD, removable hard drive, memory stick, or floppy disk writer.

In some aspects, the imaging device scanner 104 transmits a delivery failure message, in response to failing to send, or incompletely sending the scanned image data to the connected device. Then, the authorization module 120 credits the account 124 in response to receiving the delivery failure message. Note, the delivery failure message may be sent directly from the scanner 104 to the authorization module 120, or indirectly through the measurement module 112, costing module 116, or both modules 112 and 116.

### Functional Description

Pre-Count Through Document Feeder

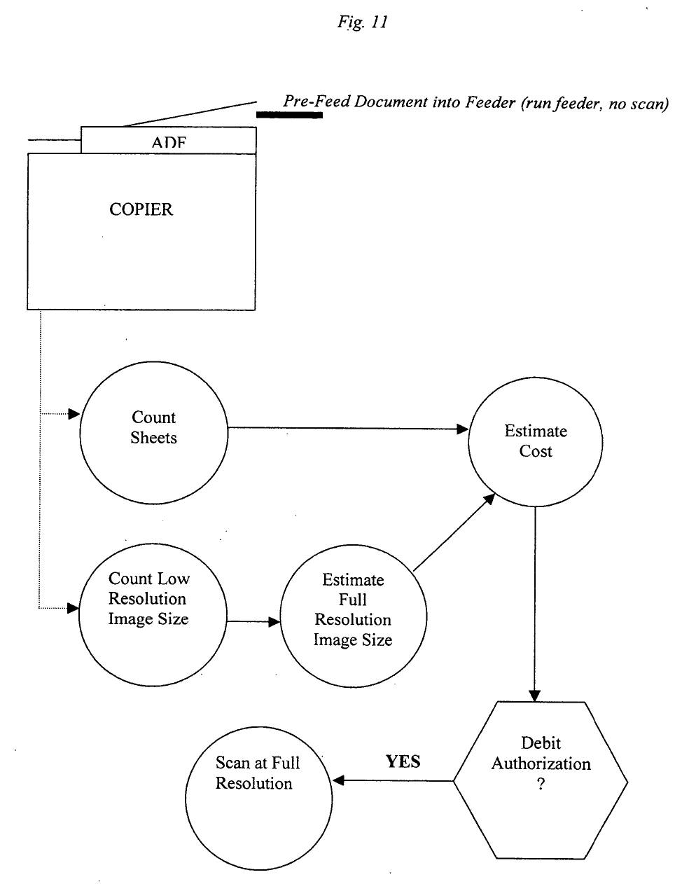

FIG. 11 is a diagram illustrating the hardcopy measurement aspect of the system. In this aspect, the hardcopy input for the network scan or scan-to-image store operation is passed twice through the imaging device. The hardcopy input may consist of single sheets or groups of sheets (i.e., documents). The hardcopy may be feed automatically, such as by an automatic document feeder (ADF) or manually, such as placing the sheets on the platen. The input may also be a mixture of document types and input using different means. Additionally, the input may also be of mixed paper size and stock. The input may also be double sided and read by a duplex scanner, such as a reversing automatic document feeder (RADF).

The user may also select various scanning options, such as cropping, gray scales, color adjustment, resolution, compression, and output format (e.g., TIFF, PDF). The user may also select the destination of the scanned image data, such as a scan to user's desktop (e.g., network scan), scan-to-application, scan-to-image store. The destination of the scanned image data may reside in the device, a client host, an imaging or document server, or offline storage. The output may also be post-processed, such as encrypting the scanned image data or OCR.

During the first pass, the hardcopy inputs are feed into the device without being scanned. During this first pass, the device determines at least some of the following factors: the number of sheets; the size of sheets; and, whether the sheets are single or double-sided.

The imaging device then connects to a debit authorization system. The debit authorization system may reside in the device, another computing device (e.g., accounting server), an external device attached to the imaging device (e.g., mini-terminal), or distributed across some combination thereof.

An estimation of the cost of the entire job is then made based on the data collected on the first pass. This estimation may be made either by the imaging device and passed to the debit authorization system, or the collected data is passed to the debit authorization system, which makes the cost estimation. The cost estimation may also factor in scanning and destination options selected by the user, such as resolution, encryption, and embedding digital signatures.

The imaging device may also send account identification information to the debit authorization system. This information may be pre-determined, manually entered (e.g., keyboard), or obtained from a magnetic swipe card, biometric reader, or a smart card. In other systems, such as with a coin-op, no account identification is required.

The debit authorization system then determines if the user has sufficient funds to complete the operation. In the case of a coin-op or charge system (e.g., credit card swipe), the user is prompted to enter the appropriate amount of currency or approval of charge. The debit authorization system then communicates back to the imaging device whether the job is authorized or not. If the job is not authorized, the imaging device ejects the hardcopy inputs into the output original collecting bins.

Otherwise, the hardcopy inputs are passed through the document feeders, or other inputs, and scanned at full resolution and post-processed according to the selected scanning options. The scanned image data is then sent to the specified destination, such as a desktop or image store.

Low-Resolution Pre-Scanning Through the Document Feeder

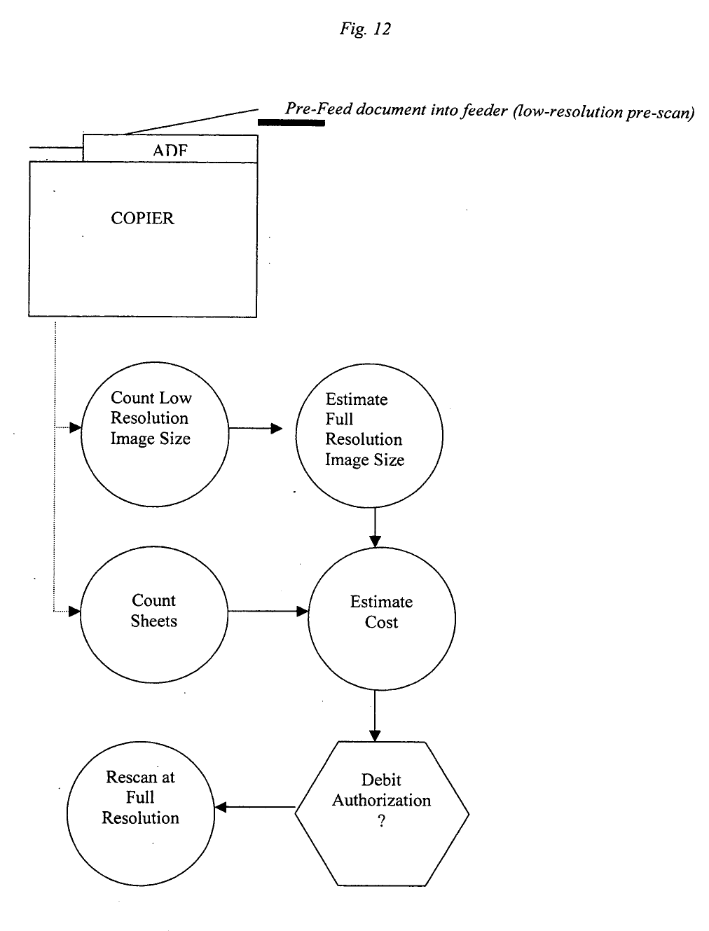

FIG. 12 is a diagram featuring the low-resolution, pre-authorization scanning of the document. On the first pass, the hardcopy input is scanned at a low-resolution, such as 75 dpi. The scanned image data is examined to categorize according to a pre-determined set of features. For examples: black-and-white vs. color, or text vs. graphics vs. photographic. The total size (i.e., non-whitespace) of the low-resolution image data is counted, per category. For each side of a sheet scanned (whether simplex or duplex), a check is made of the low-resolution output to determine if the sheet, or sheet side, is blank. If blank, the sheet, or sheet side, is not counted.

Note, some image data may appear as noise even in a blank scan. The determination of a blank sheet is usually made by checking, the amount of non-whitepace image data produced, against a pre-determined threshold. If the total is below the threshold, the scan is assumed to be blank.

During the debit authorization process an estimate is made of the total full resolution scanned image data from the low-resolution scanned image data, on a per category basis. For example, a linear estimation may be used that is proportional to the full resolution. For example, if the low-resolution is 75 dpi and the full resolution is 300 dpi, then the estimated full resolution would be calculated as the ratio (300/75) multiplied against the low-resolution total. The full resolution image data estimates may be used as part of the cost determination. The low-resolution data is discarded.

Full-Resolution Scan and Hold in Temporary Storage

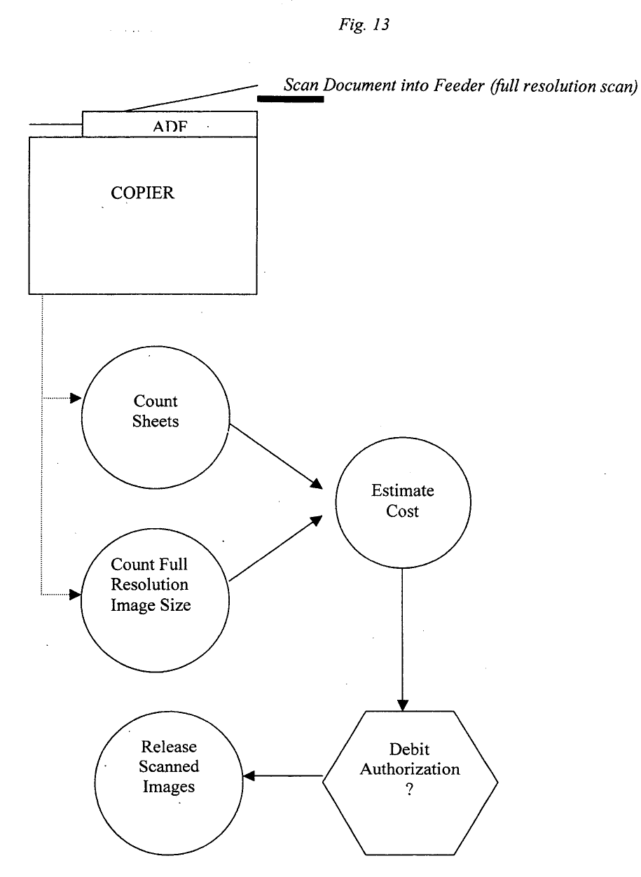

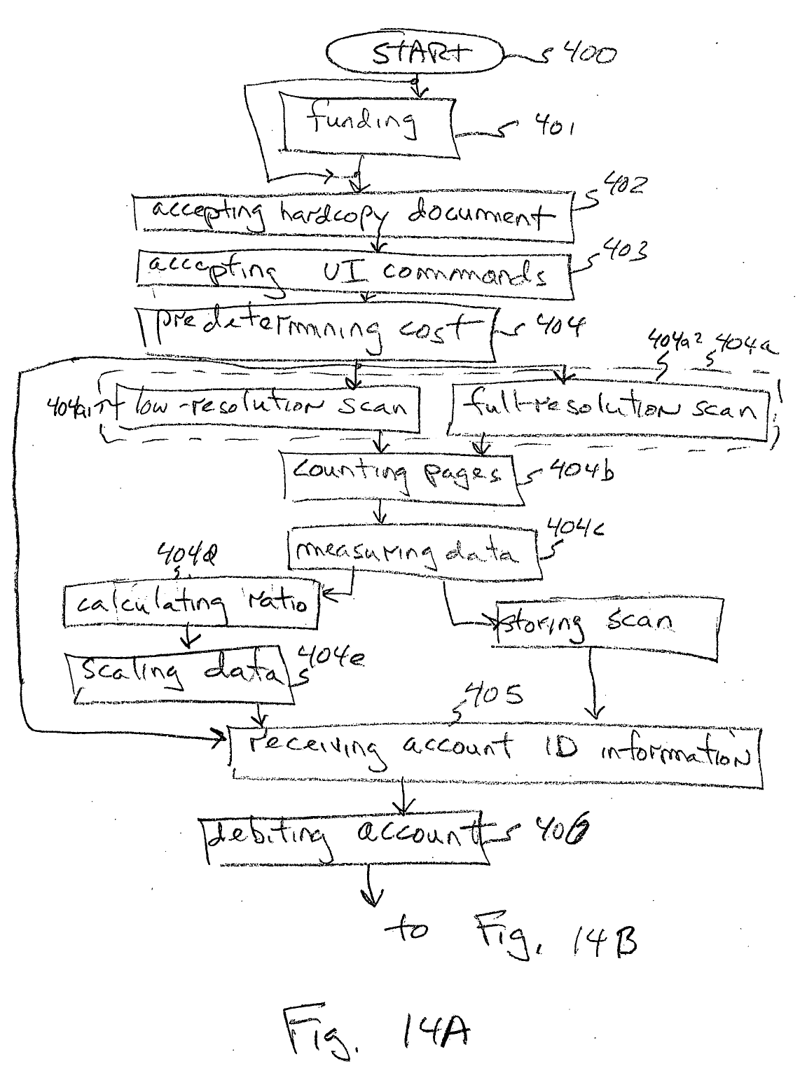

FIG. 13 is a diagram illustrating the full-resolution aspect of the network scan debit authorization system. The hardcopy input is only passed through the device once. The hardcopy input is scanned at full resolution according to the user's selected scanning options. The total size (i.e., non-whitespace) of the full-resolution image data is counted, per category. At this point, the post-processing may optionally occur (e.g., encryption, OCR).

During the debit authorization process the full-resolution image data size may be used as part of the cost determination. The full-resolution image data is held temporary in storage. The storage may reside in the device, a server, or offline. If the job is not authorized, the full resolution data is discarded. If the job is authorized, the full-resolution data is post-processed (if it has not already occurred) and sent to the specified destination.

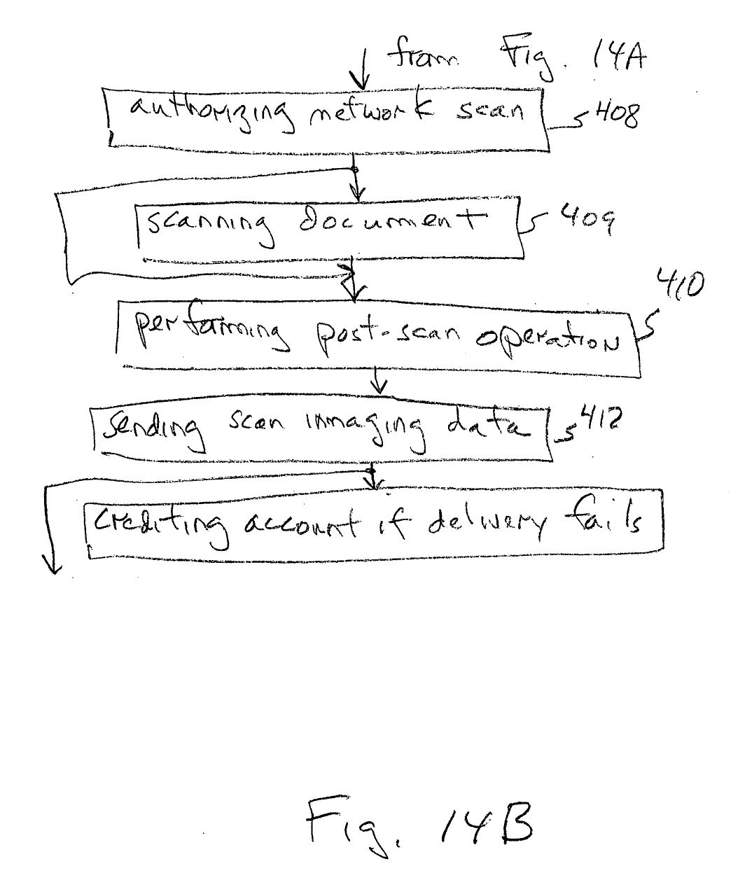

FIGS. 14A and 14B are flowcharts illustrating a method for network scan debt authorization. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence.

The method starts at Step 400. Step 402 accepts a hardcopy document at an imaging device. Step 404 predetermines the cost for scanning the document. Step 406 debits an account. Step 408 authorizes a network scan. Step 412 sends the scanned image data to a destination. Step 414 credits the account in the event of a delivery failure in sending the scanned image data to the destination.

Predetermining the cost of scanning the document in Step 404 includes using a process such as measuring the hardcopy document or measuring a scanned image data version of the hardcopy document.

For example, if the hardcopy document is measured, then information is collected such as the number of sheets, the sheet sizes, or the sheet sides used (simplex/duplex). Then, Step 409 scans the document in response to the debt authorization, creating scanned image data. In one aspect, counting the number of sheets includes using a document feed process such as singly counting sheets placed on an imaging device platen, or automatically counting sheets passed through an imaging device document feeder.

Alternately, if image pages are measured in a scanned image data version of the hardcopy document, Step 404 includes substeps. Step 404a scans the document. Step 404b counts the number of image pages in the scanned image data. For example, Step 404a1 may low-resolution scan the document. Step 404c may measure the amount of data associated with each image page. Note, Step 404c may occur as an alternative to Step 404b, or in combination with Step 404b. Step 404d calculates a low-resolution/full-resolution ratio. Note, the ratio is likely to be pre-calculated. Step 404e scales the data by the calculated ratio. Then, Step 409 scans the document in response to the debit authorization, creating a full-resolution scanned image data, and Step 412 sends the full-resolution scanned image data.

Alternately, Step 404a2 high-resolution scans the document. Step 404f stores the full-resolution scanned image data. Then, sending the scanned image data in Step 412 includes sending the full-resolution scanned image data from storage in response to the authorization. As with the low-resolution pre-scan, Step 404c may measure the amount of data associated with each full-resolution image page, in addition to, or as an alternative to an image page-count.

In one aspect, Step 403 accepts user interface (UI) commands. In response to the UI commands, scanning options are performed such as cropping, gray scale, color adjustment, resolution, compression, or output format processes. Note, depending on the aspect, this operation occurs in association with Step 404a2 or Step 409. Then, Step 406 debits the account in response to selected scanning options.

In another aspect, post-scanning operations are performed in Step 410, in response to the UI commands of Step 403. Some post-scanning options include encryption, embedding digital signatures, annotation, and optical character recognition (OCR) processes. For the full-resolution pre-authorization scan, the post-scan processes may occur anytime after the performance of Step 404a2. Again, Step 406 additionally debits the account in response to selected post-scanning options.

In one aspect Step 405, prior to debiting the account, receives account identification information using a process such as manual (keyboard) entry, a magnetic card reader, optical reader, barcode scanner, biometric reader, or a smart card reader. In a different aspect, Step 401 funds the account by accepting currency via an imaging device currency feeder or debiting a credit account via a credit/debit card reader.

Step 406 may include debiting an account residing in a device such as the imaging device, a network-connected account server, a locally-connected computing device, a network-connected computing device, or another imaging device connected to the imaging device. More specifically, debiting an account in Step 406 includes substeps (not shown). Step 406a accesses the account. Step 406b determines available funds in the account. Then, authorizing a network scan in Step 408 includes authorizing in response to successfully deducting the debited amount from the available funds.

In another aspect, sending the scanned image data to a destination is Step 412 includes sending the scanned image data to a destination supplied in the UI commands (Step 403). Step 406 may optionally determine cost on the basis of the destination locale, transmission services used to reach the destination, or any storage services used in route to, or at the destination. Step 412 may send the scanned image data to a destination such as a network-connected device, a locally-connected device, imaging device storage, or a removable storage medium.

A network scan debit authorization system and method have been provided. Examples of destinations, scanning processes, funding, and specific authorization procedures have been given to illustrate the invention. However, the invention is not limited to merely these examples. It should also be appreciated that the above-described invention can be applied to other services involving the scanning of hardcopy documents, where it has conventionally been difficult to determine the scope of the job, and so debit an account, prior to actually performing the task. Other variations and embodiments of the invention will occur to those skilled in the art.

We claim:

1. A method for network scan debt authorization, the method comprising:
at an imaging device, accepting a hardcopy document;
predetermining the cost for scanning the document;
debiting an account;
authorizing a network scan; and,
sending the scanned image data to a destination.

2. The method of claim 1 wherein predetermining the cost of scanning the document includes using a process selected from the group including measuring the hardcopy document and measuring a scanned image data version of the hardcopy document.

3. The method of claim 2 further comprising:
accepting user interface (UI) commands;
in response to the UI commands, performing scanning options selected from the group including cropping, gray scale, color adjustment, resolution, compression, and output format; and,
wherein debiting an account includes debiting the account in response to selected scanning options.

4. The method of claim 2 further comprising:
accepting user interface (UI) commands;
in response to the UI commands, performing post-scanning options selected from the group including encryption, embedding digital signatures, annotation, and optical character recognition (OCR); and,
wherein debiting an account includes debiting the account in response to selected post-scanning options.

5. The method of claim 2 wherein debiting an account includes debiting an account residing in a device selected from the group including the imaging device, a network-connected account server, a locally-connected computing device, a network-connected computing device, and another imaging device connected to the imaging device.

6. The method of claim 2 further comprising:
prior to debiting the account, receiving account identification information using a process selected from the group including manual (keyboard) entry, a magnetic card reader, optical reader, barcode scanner, biometric reader, and a smart card reader.

7. The method of claim 2 wherein debiting an account includes:
accessing the account;
determining available funds in the account; and,
wherein authorizing a network scan includes authorizing in response to successfully deducting the debited amount from the available funds.

8. The method of claim 1 further comprising:
funding the account using a process selected from the group including accepting currency via an imaging device currency feeder and debiting a credit account via a credit/debit card reader.

9. The method of claim 2 further comprising:
accepting UI commands;
wherein sending the scanned image data to a destination includes sending the scanned image data to a destination supplied in the UI commands; and,
wherein predetermining the cost of scanning the document includes determining cost on the basis of the destination locale, transmission services, and storage services.

10. The method of claim 2 wherein measuring the hardcopy document includes collecting information selected from the group including the number of sheets, the sheet sizes, and the sheet sides used (simplex/duplex).

11. The method of claim 10 further comprising:
scanning the document in response to the debt authorization, creating scanned image data.

12. The method of claim 11 wherein counting the number of sheets includes using a document feed process selected from the group including singly counting sheets placed on an imaging device platen and automatically counting sheets passed through an imaging device document feeder.

13. The method of claim 2 wherein measuring image pages in a scanned image data version of the hardcopy document includes:
scanning the document; and,
counting the number of image pages in the scanned image data.

14. The method of claim 2 wherein measuring image pages in a scanned image data version of the hardcopy document includes:
low-resolution scanning the document;
measuring the amount of data associated with each image page;
calculating a low-resolution/full-resolution ratio; and,
scaling the data by the calculated ratio.

15. The method of claim 14 further comprising:
scanning the document in response to the debit authorization, creating a full-resolution scanned image data; and,
wherein sending the scanned image data to a destination includes sending the full-resolution scanned image data.

16. The method of claim 2 wherein measuring image pages in a scanned image data version of the hardcopy document includes:
high-resolution scanning the document; and,
storing the full-resolution scanned image data; and,
wherein sending the scanned image data to a destination includes sending the full-resolution scanned image data from storage in response to the authorization.

17. The method of claim 16 wherein measuring image pages in a scanned image data version of the hardcopy document includes measuring the amount of data associated with each full-resolution image page.

18. The method of claim 1 wherein sending the scanned image data to a destination includes sending to a destination selected from the group including a network-connected device, a locally-connected device, imaging device storage, and a removable storage medium.

19. The method of claim 1 further comprising:
in the event of a delivery failure in sending the scanned image data to the destination, crediting the account.

20. A network scan debt authorization system, the system comprising:
an imaging device including:
a scanner having interfaces to accept a hardcopy document, to accept a network scan authorization, and to supply scanned image data of the hardcopy document in response to a network scan authorization; and,
a measurement module having an interface to supply measurements associated with the document;
a costing module having interfaces to accept the document measurements and to supply an predetermined cost for scanning the document in response to the document measurements; and,
an authorization module having an interface to accept the predetermined cost, the authorization module debiting an account in response to the predetermined cost, and supplying the network scan authorization at an interface.

21. The system of claim 20 wherein the imaging device includes a document feeder; and,
the measurement module supplies measurements associated with the document using a process selected from the group collecting information associated with the hardcopy document from the document feeder and measuring a scanned image data version of the hardcopy document.

22. The system of claim 21 wherein the imaging device includes:
a user interface (UI) having an interface to supply commands;
wherein the imaging device scanner has an interface to accept the UI commands, and in response to the UI commands, perform scanning options selected from the group including cropping, gray scale, color adjustment, resolution, compression, and output format; and,
wherein the costing module supplies an predetermined cost in response to selected scanning options.

23. The system of claim 21 wherein the imaging device includes:
a UI having an interface to supply commands;
wherein the imaging device scanner has an interface to accept the UI commands, and in response to the UI commands, perform post-scanning options selected from the group including encryption, embedding digital signatures, annotation, and optical character recognition (OCR); and,
wherein the costing module supplies an predetermined cost in response to selected post-scanning options.

24. The system of claim 21 wherein the authorization module resides in a device selected from the group including the imaging device, a network-connected account server, a locally-connected computing device, a network-connected computing device, and another imaging device connected to the imaging device.

25. The system of claim 24 wherein the costing module resides with an entity selected from the group including the imaging device and the authorization module.

26. The system of claim 21 wherein the imaging device includes a UI selected from the group including a keyboard, a magnetic card reader, optical reader, barcode scanner, biometric reader, and a smart card reader; and,
wherein the authorization module, prior to debiting the account, receives account identification information via the imaging device

27. The system of claim 21 wherein the authorization module accesses the account, determines available funds in the account, and supplies the network scan authorization in response to successfully deducting the debited amount from the available funds.

28. The system of claim 20 wherein the imaging device includes an interface selected from the group including a currency feeder and credit/debit card reader; and,
wherein the authorization module funds the account using a process selected from the group including accepting credit via the currency feeder and debiting a credit account via the credit/debit card reader.

29. The system of claim 21 wherein the imaging device includes:
a UI having an interface to supply commands;
wherein the imaging device scanner sends the scanned image data to a destination supplied in the UI commands; and,
wherein costing module predetermines the cost of scanning the document on the basis of the destination locale, transmission services, and storage services.

30. The system of claim 21 wherein the measurement module collects information from the document feeder selected from the group including the number of sheets, the sheet sizes, and the sheet sides used (simplex/duplex).

31. The system of claim 30 wherein the imaging device feeder is a device selected from the group including a scanner platen and an automatic document feeder; and,
wherein the measurement module counts the number of sheets in the hardcopy document using a process selected from the group including singly counting sheets placed on the platen and receiving a total sheet count from the automatic document feeder.

32. The system of claim 21 wherein the imaging device scanner scans the hardcopy document prior to receiving the network scan authorization; and,
wherein the measurement module measures image pages in a scanned image data version of the hardcopy document by counting the number of image pages in the scanned image data.

33. The system of claim 21 wherein the imaging device scanner scans the hardcopy document in low resolution prior to receiving the network scan authorization; and,
wherein the measurement module measures the amount of data associated with each image page, calculates a low-resolution/full-resolution ratio, and scales the data by the calculated ratio.

34. The system of claim 33 wherein the imaging device scanner scans the document in full resolution in response to receiving the network scan authorization, and sends the full-resolution scanned image data.

35. The system of claim 21 wherein the imaging device scanner scans the hardcopy document in full resolution prior to receiving the network scan authorization, stores the full-resolution scanned image data, and sends the full-resolution scanned image data from storage in response to receiving the network scan authorization.

36. The system of claim 35 wherein the measurement module measures the amount of data associated with each full-resolution image page.

37. The system of claim 20 further comprising:
a connected device selected from the group including a network-connected device, a locally-connected device, imaging device storage, and a removable storage medium; and,
wherein the imaging device scanner sends the scanned image data to the connected device in response to receiving the network scan authorization.

38. The system of claim 37 wherein the imaging device scanner transmits a delivery failure message, in response to failing to send the scanned image data to the connected device; and,
wherein the authorization module credits the account in response to receiving the delivery failure message.
